(19) United States
(12) Patent Application Publication
(10) Pub. No.: US 2017/0308839 A1
(43) Pub. Date: Oct. 26, 2017

(54) WORK ORDER GENERATION AND MANAGEMENT

(71) Applicant: Ryan Bonham, Provo, UT (US)

(72) Inventor: Ryan Bonham, Provo, UT (US)

(21) Appl. No.: 15/134,229

(22) Filed: Apr. 20, 2016

(51) Int. Cl. G06Q 10/06; G06Q 10/00

(52) U.S. Cl. CPC G06Q 10/063112; G06Q 10/20

(57) ABSTRACT

For work order generation and management, a method receives a service task for a homeowners' association resident. The maintenance task includes a task category and a task location. The method further generates a work order directed to a maintenance worker profile based on the task category and the task location. The maintenance worker profile satisfies the task category and the task location. In addition, the method generates a work order summary.

### FIELD

The subject matter disclosed herein relates to work orders and more particularly relates to work order generation and management.

### BACKGROUND

### Description of the Related Art

A homeowners' association often receives, tracks, and completes service tasks for homeowners.

### BRIEF SUMMARY

A method for work order generation is disclosed. The method receives a service task for a homeowners' association resident. The maintenance task includes a task category and a task location. The method further generates a work order directed to a maintenance worker profile based on the task category and the task location. The maintenance worker profile satisfies the task category and the task location. In addition, the method generates a work order summary. An apparatus and program product also perform the functions of the method.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a work order system;

FIG. 2A is a schematic block diagram illustrating one embodiment of a work order database;

FIG. 2B is a schematic block diagram illustrating one embodiment of a service task;

FIG. 2C is a schematic block diagram illustrating one embodiment of a task category;

FIG. 2D is a schematic block diagram illustrating one embodiment of a task location;

FIG. 2E is a schematic block diagram illustrating one embodiment of homeowners' association (HOA) data;

FIG. 3A is a schematic block diagram illustrating one embodiment of a maintenance worker profile;

FIG. 3B is a schematic block diagram illustrating one embodiment of a work order;

FIG. 3C is a drawing illustrating one embodiment of a maintenance worker work order summary;

FIG. 3D is a drawing illustrating one embodiment of a work order summary;

FIG. 4 is a schematic block diagram illustrating one embodiment of a computer;

FIG. 5A is a schematic flow chart diagram illustrating one embodiment of a work order management method; and

FIG. 5B is a schematic flow chart diagram illustrating one embodiment of a work order generation method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage medium storing machine readable code, computer readable code, and/or program code, referred hereafter as code. The computer readable storage medium may be tangible, non-transitory, and/or non-transmission. The computer readable storage medium may not embody signals. In a certain embodiment, the storage devices only employ signals for accessing code.

The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

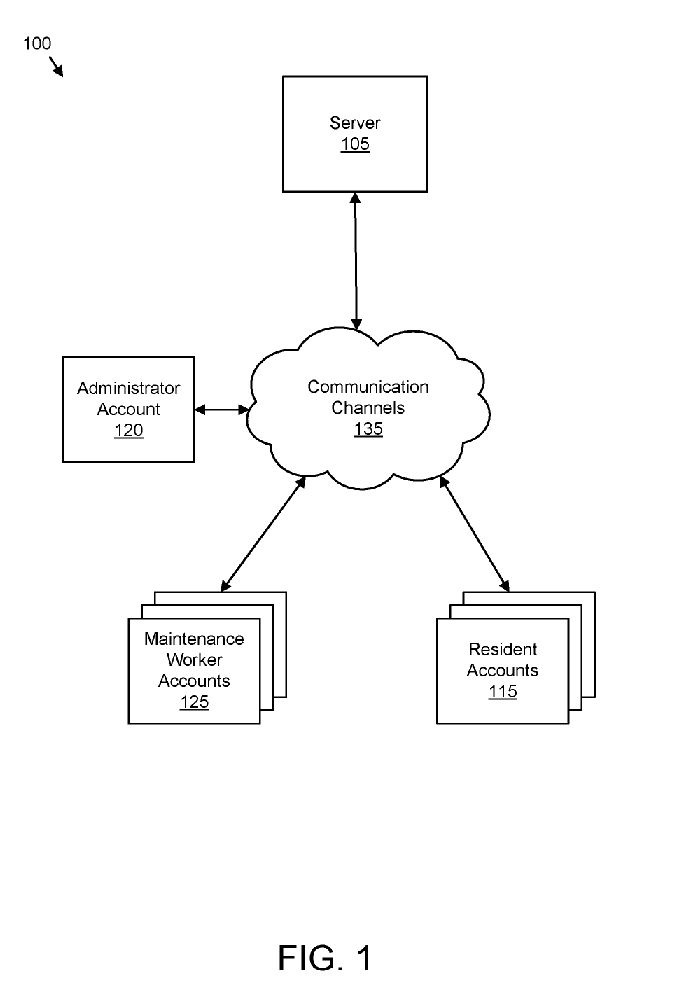

FIG. 1 is a schematic block diagram illustrating one embodiment of a work order system 100. The system 100 may generate work orders from service tasks for HOA residents. In the depicted embodiment, the system 100 includes a server 105, an administrator account 120, maintenance worker accounts 125, resident accounts 115, and communication channels 135.

The server 105 may maintain a work order database. The server 105 may communicate with the administrator account 120, the maintenance worker accounts 125, and the resident accounts 115 through the communication channels 135. The communication channels 135 may comprise one or more of the Internet, a mobile telephone network, an instant messaging system, a wide area network, a local area network, or combinations thereof. The communication channels 135 may transmit messages. The messages may be organized as digital data packets, analog signals, or the like.

The resident accounts 115 may allow residents of a homeowners' association or other resident based organization to request services. The server 105 may receive service tasks from the resident accounts 115 and generate the work orders from the service tasks. The server 105 may further assign the work orders to one or more maintenance worker accounts 125. The administrator account 120 may manage the work orders for the maintenance worker accounts 125 generated by the server 105.

In the past, service tasks have been logged into a database and then assigned to maintenance workers as work orders. The assignment of the work orders is relatively simple when there is a small number of maintenance workers and/or when most or all maintenance workers are capable of completing all work orders. However, as the number of work orders, maintenance workers, and maintenance worker skill levels increase, efficiently generating work orders and assigning the work orders to maintenance workers becomes intractably complicated.

The embodiments described herein generate work orders directed to a maintenance worker profile based on a task category and a task location such that the maintenance worker profile satisfies the task category and the task location. As a result, the work orders are more efficiently generated and assigned as will be described hereafter.

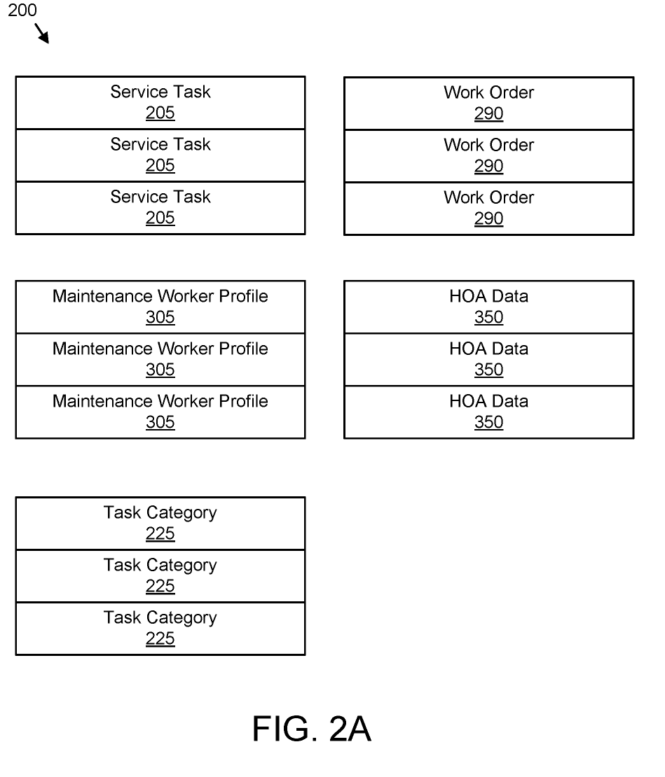

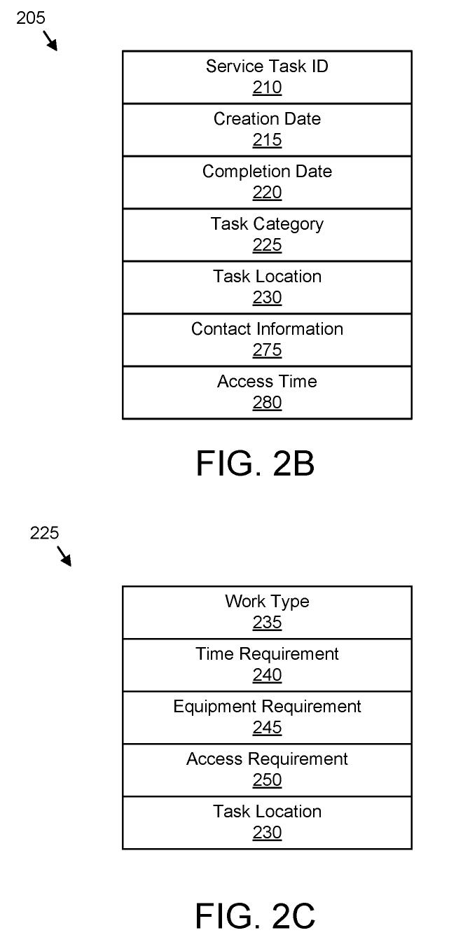

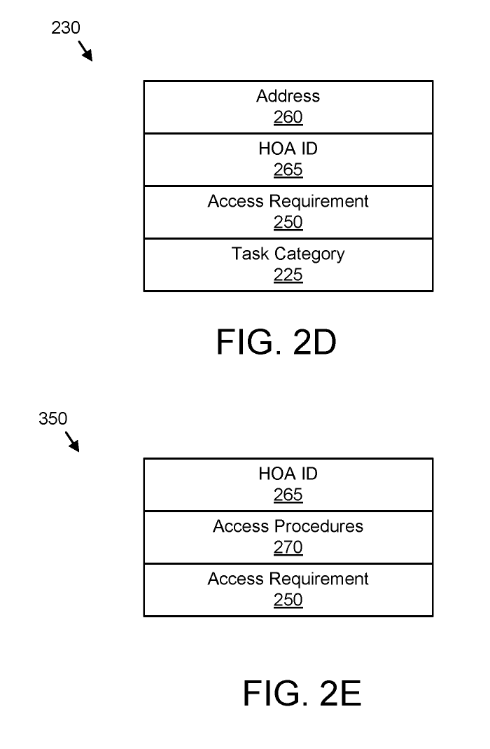

FIG. 2A is a schematic block diagram illustrating one embodiment of a work order database 200. The work order database 200 may be organized in a memory. In the depicted embodiment, the work order database 200 includes one or more service tasks 205, one or more work orders 290, one or more maintenance worker profiles 305, one or more HOA data instances 350, and one or more task categories 225.

The service tasks 205 may be submitted by residents of one or more HOA. In one embodiment, a resident may employ a resident account 115 to generate the service task 205 and communicate the service tasks through the communication channels 135 to the server 105. The service tasks 205 are described in more detail in FIG. 2B.

The task categories 225 may be used to generate a work order 290 that is directed to an optimal maintenance worker profile 305. The task categories 225 are described in more detail in FIG. 2C.

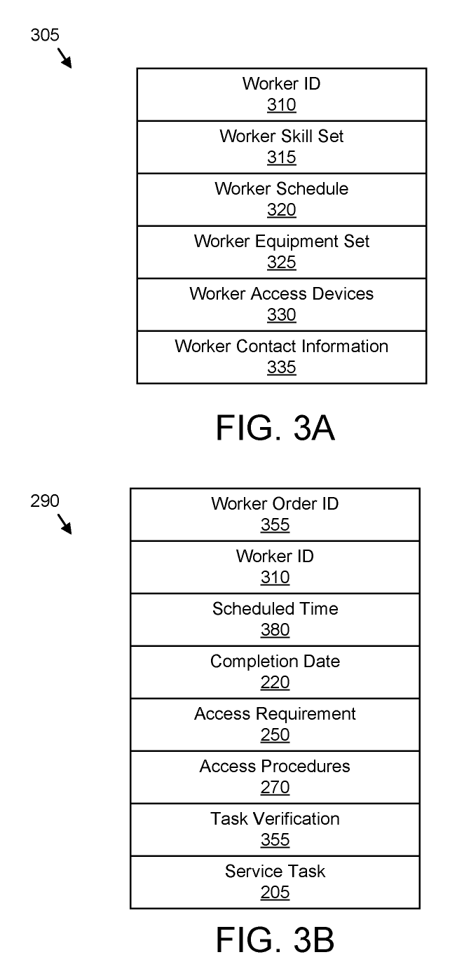

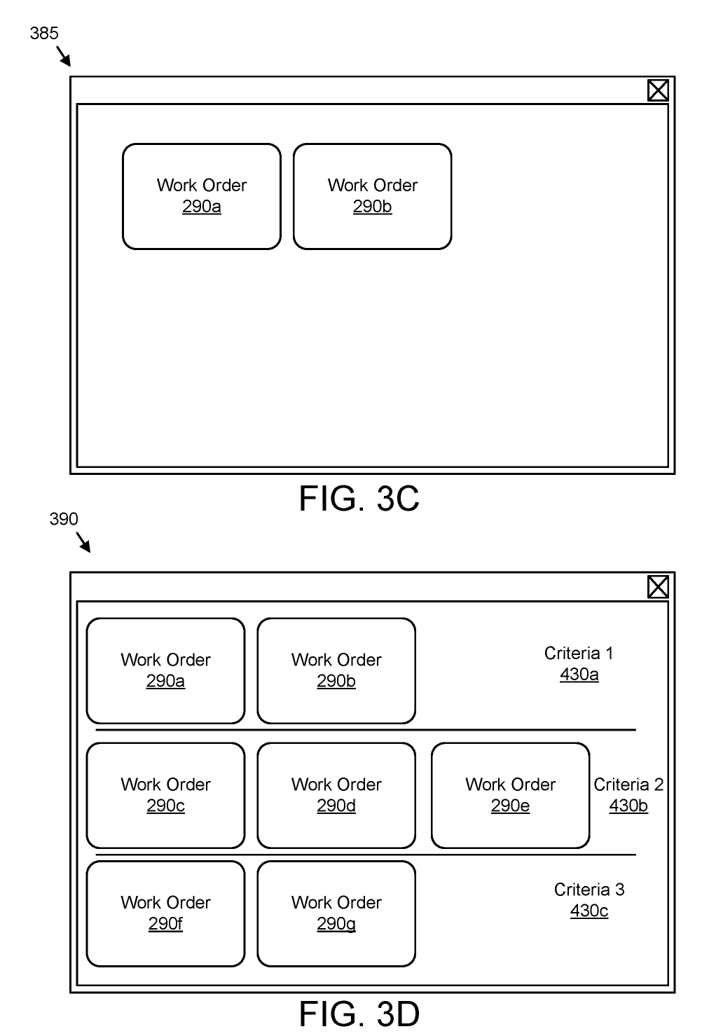

The maintenance worker profiles 305 may be used along with the task categories 225 to generate the work order 290. The maintenance worker profiles 305 are described in more detail in FIG. 3A.

The server 105 may generate the work orders 290 to efficiently use the maintenance workers corresponding to the maintenance worker profiles 305 to perform the service tasks requested by the HOA residents. The work orders 290 are described in more detail in FIG. 3B.

The HOA data 350 may describe access procedures and access requirements for the maintenance worker to access a residence, building, or space and complete the work order 290. The HOA data 350 is described in more detail in FIG. 2E.

FIG. 2B is a schematic block diagram illustrating one embodiment of a service task 205. The service task 205 may be organized as a data structure in the memory. In the depicted embodiment, the service task 205 includes a service task identifier 210, a creation date 215, a completion date 220, a task category 225, a task location 230, contact information 275, and an access time 280.

The service task identifier 210 may uniquely identify the service task 205. In one embodiment, the service task identifier 210 is an alphanumeric string. The creation date 215 may comprise a timestamp that indicates when the resident submitted the service task 205 to the server 105.

The completion date 220 may record when all work orders 290 for the service task 205 are complete. In addition, the completion date 220 may record when each work order 290 for the service task 205 is completed.

The task category 235 may specify one or more types of work that are required to complete the service task 205. For simplicity, a single task category 225 is shown. However, the service task 205 may include one or more task categories 235. The task category 225 is described in more detail in FIG. 2C.

The task location 230 may specify one or more locations where work must be performed to complete the service task 205. For simplicity, a single task location 230 is shown. However, the service task 205 may include one or more task locations 230. The task location 230 is described in FIG. 2D. In one embodiment, a task category 235 may be linked to a task location 230.

The contact information 275 may specify a phone number, an email address, and similar information for the resident requesting the service task, a property manager, or the like. The contact information 275 may be used by the server 105 to schedule a work order 290. The access time 280 may specify one or more time intervals when the task location 230 may be accessed in order to perform the service task 205.

FIG. 2C is a schematic block diagram illustrating one embodiment of the task category 225. The task category 225 may be organized as a data structure in the memory. In the depicted embodiment, the task category 225 includes a work type 235, a time requirement 240, an equipment requirement 245, an access requirement 250, and the task location 230.

The work type 235 may specify a work classification and minimum skills, training, and certifications required to perform the work. In one embodiment, the work type 235 specifies minimum skills, training, and certifications. In addition, the work type 235 may specify skills, training, and certifications for additional skill levels of more qualified maintenance workers. Table 1 describes work type elements that may be included in the work type 235 and a description of each work type.

TABLE 1

| Work Type | |
|---|---|
| Element | Work Type Description |
| Work Classification | A classification of the work to be performed. |
| | The work classification may be the Standard |
| | Occupational Classification defined by the |
| | Bureau of Labor Statistics. Alternatively, the |
| | work classification may be a custom work |
| | classification. |
| Relevant Work | A time interval of related work experience |
| Experience | that may be required to perform a service task 205. |
| Required Training | Training that may be required to perform the |
| | service task 205. |
| Required | A certification that may be required to |
| Certification | perform the service task 205. |
| Union Requirement | The service task must be performed in |
| | accordance with local union work rules. |

In one embodiment, each work type element includes a value. When the work element type is associated with the work type 235, the value may be a minimum required value that a maintenance worker must have in order to be qualified to perform the work type 235. Alternatively, when the work type element is associated with a worker skill set of a maintenance worker profile 305, the value may be a worker value that estimates the maintenance worker's level of proficiency for the work type element.

The time requirement 240 may specify a time needed to perform the service task 205 for a maintenance worker with a worker skill set that satisfies the task category 235. The time requirement 240 may specify the time for the minimum skills, training, and certifications of the task category 235. In addition, the time requirement 240 may specify the time for the additional skill levels of the task category 235.

The equipment requirement 245 may specify equipment that is required to perform the service task 205. The equipment requirement 245 may specify a generalized set of equipment. Alternatively, the equipment requirement 245 may specify one or more specific pieces of equipment.

The access requirement 250 may specify one or more requirements for accessing the task location 230. Table 2 lists some access requirements 250.

TABLE 2

| Access Requirement | Description |
|---|---|
| Exterior Access | Access by the maintenance worker to an |
| | exterior of a building or space. |
| Interior Access | Access by the maintenance worker to an |
| | interior of the building. |
| Water Shut Off | Shut off of water to the building or space. |
| Electrical Shut Off | Shut off of electricity to the building or space. |
| Gas Shut Off | Shut off of gas to the building or space. |
| Decision Maker | An authorized decision-maker must be present |
| | to authorize work. |
| Keys | An identifier for one or more keys required to |
| | access the task location 230. |
| Passcode | One or more passcodes required to access the |
| | task location 230. |

FIG. 2D is a schematic block diagram illustrating one embodiment of a task location 230. The task location 230 may be organized as a data structure in the memory. In the depicted embodiment, the task location 230 includes an address 260, an HOA identifier 265, the access requirement 250, and the task category 225.

The address 260 may specify where the service task 205 is to be performed. The address 260 may be a street address, a global positioning system (GPS) coordinate, site specific directions, or combinations thereof. The HOA identifier 265 may identify HOA data 350 associated with the task location 230.

In one embodiment, the access requirement 250 of the task location 230 includes requirements that are specific to the task location 230. For example, the access requirement 250 for the task location 230 may specify that an authorized decision maker is present. In addition, the task category 225 may include work type elements that are specific to the task location 230. For example, the task category 225 for the task location 230 may specify a union requirement.

FIG. 2E is a schematic block diagram illustrating one embodiment of the HOA data 350. The HOA data 350 may be organized as a data structure in the memory. In the depicted embodiment, the HOA data 350 includes the HOA identifier 265, access procedures 270, and the access requirement 250.

The HOA identifier 265 may uniquely identify an HOA or similar organization. The HOA identifier 265 may be an alphanumeric string. The access procedures 270 may specify how a maintenance worker is to access the task location 230. The access procedures 270 may include passcodes, directions to shutting off water, electric, and gas for the task location 230, directions to use the contact information 275, and the like.

The access requirement 250 of the HOA data 350 may include requirements that are specific to the HOA. For example, the access requirements 250 for the HOA may include hours that service tasks 205 may be performed.

FIG. 3A is a schematic block diagram illustrating one embodiment of a maintenance worker profile 305. The maintenance worker profile 305 may be organized as a data structure in the memory. In the depicted embodiment, the maintenance worker profile 305 includes a worker identifier 310, a worker skill set 315, a worker schedule 320, a worker equipment set 325, worker access devices 330, and worker contact information 335.

The worker identifier 310 may uniquely identify a maintenance worker. The worker identifier 310 maybe a name, an alphanumeric string, or combinations thereof.

The worker skill set 315 includes one or more work types 235 that the maintenance worker may perform. In one embodiment, each work type 235 specifies one or more of the work type elements of Table 1 for the maintenance worker. Each work type element includes a worker value that estimates the maintenance worker's ability to perform the work type element of the work type 235.

The worker schedule 320 specifies when the maintenance worker is available to perform a work order 290 for a service task 205. The worker schedule 320 may include all times that the maintenance worker is available for duty. In addition, the worker schedule 320 may include times that the maintenance worker is not scheduled for other work orders 290.

The worker equipment set 325 may list equipment sets and/or pieces of equipment that are available to the maintenance worker. In addition, the worker equipment set 325 may specify where each equipment set and/or piece of equipment is available to the maintenance worker. For example, the worker equipment set 325 may specify that a first equipment set is available to the maintenance worker in the maintenance worker's vehicle and that a second equipment set is available to the maintenance worker from a shop.

The worker access devices 330 may specify access devices that are available to the maintenance worker. The access devices may include keys, passcodes, and the like. The worker access devices 330 may specify where each access device is available to the maintenance worker. For example, the worker access devices 330 may specify that a first passcode is carried on the person of the maintenance worker and that a first key is available to the maintenance worker from an HOA office.

The worker contact information 335 may include one or more of a phone number, an email address, a maintenance worker account 225, and the like through which the maintenance worker may be contacted. In addition, the worker contact information 335 may specify the communication channels 135 for communicating a work order 290 to the maintenance worker.

FIG. 3B is a schematic block diagram illustrating one embodiment of a work order 290. The work order 290 may be organized as a data structure in the memory. In the depicted embodiment, the work order 290 includes a work order identifier 355, the worker identifier 310, a scheduled time 380, the completion date 220, the access requirement 250, the access procedures 270, a task verification 355, and the service task 205.

The work order identifier 355 may uniquely identify the work order 290. The work order identifier 355 may be an alphanumeric string. The worker identifier 310 specifies the one or more maintenance workers that are assigned to perform the work order 290. The schedule time 380 specifies when the work order 290 is to be performed. The completion date 220 specifies when the work order 290 is completed.

The access requirement 250 may combine the access requirements 250 from the task category 225, the task location 230, and the HOA data 350. The access requirement 250 may specify all required elements for the maintenance worker to access the task location 230. The access procedures 270 may specify how the maintenance worker is to access the task location 230 to perform the work order 290. The access procedures 270 may be the access procedures 270 of the HOA data 350.

The task verification 355 may include a verification that the work order is complete. The task verification 355 may include the signature of the decision maker, an image of the completed work order 290, an attestation by the maintenance worker, or the like. The service task 205 may include the data from the original service task 205.

FIG. 3C is a drawing illustrating one embodiment of a maintenance worker work order summary 385. The maintenance worker work order summary 385 may be displayed to the maintenance worker on an electronic device. In one embodiment, the maintenance worker view 385 is embodied within the maintenance worker account 125.

In the depicted embodiment, one or more work orders 290 that are assigned to the maintenance worker are displayed. In one embodiment, only work orders 290 that are assigned to the maintenance worker are displayed. In a certain embodiment, only work orders 290 that are scheduled within a specified work order time interval are displayed for the maintenance worker. For example, only the work orders 290 for a day may be displayed to the maintenance worker.

FIG. 3D is a drawing illustrating one embodiment of a work order summary 390. The work order summary 390 may be displayed to an administrator on an electronic device. In one embodiment, the work order summary 390 is embedded within the administrator account 120.

In one embodiment, the work order summary 390 includes all active work orders 290. Alternatively, the work order summary 390 may include all active work orders 290 for one or more specified task locations 230.

In the depicted embodiment, the work order summary 390 sorts the work orders 290 based on criteria 430. The criteria 430 may comprise one or more of the maintenance worker, the HOA, and the date.

In one embodiment, the administrator may edit and/or modify the work orders 290. In addition, the administrator may divide a work order 290 and two work orders 290, delete a work order 290, and the like. As a result, the work orders 290 may be managed using the work order summary 390.

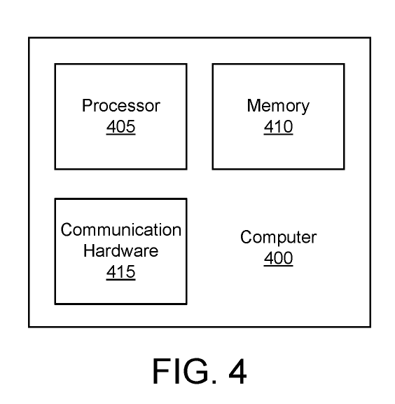

FIG. 4 is a schematic block diagram illustrating one embodiment of a computer 400. A computer 400 may be embodied in the server 105. In addition, instances of the computer 400 may host one or more of the administrator account 120, the maintenance worker accounts 125, and the resident accounts 115. In the depicted embodiment, the computer 400 includes a processor 405, memory 410, and communication hardware 415. The memory 410 may include a semiconductor storage device, hard disk drive, an optical storage device, a micromechanical storage device, or combinations thereof. The memory 410 may store code. The processor 405 may execute the code. The communication hardware 415 may communicate with other devices. For example, the communication hardware 415 may communicate with the communication channels 135.

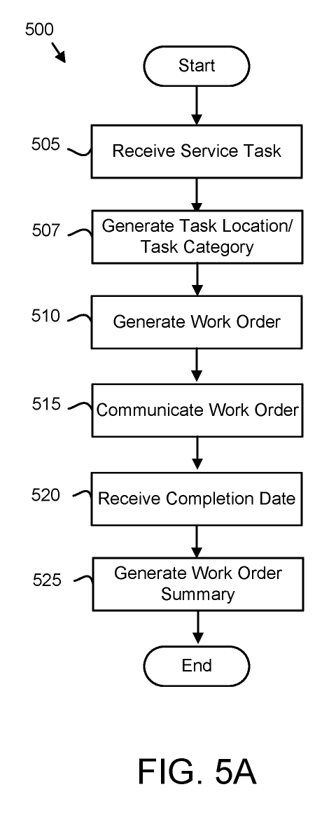

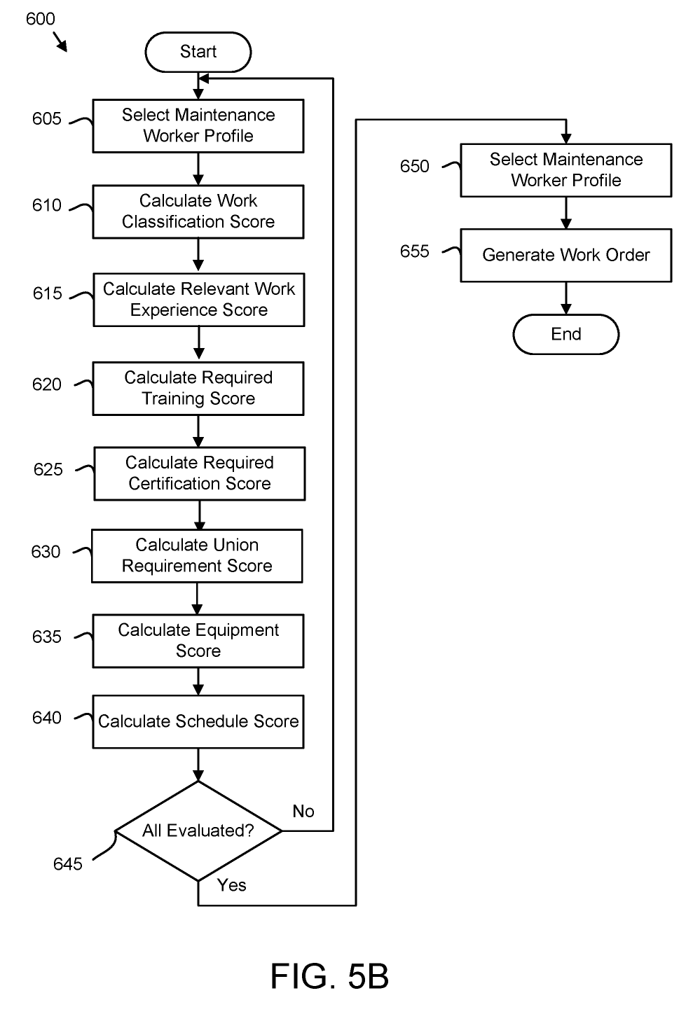

FIG. 5A is a schematic flow chart diagram illustrating one embodiment of a work order management method 500. The method 500 may generate work orders 290 from service tasks 205. In addition, the method 500 may manage the work orders 290. The method 500 may be performed by the processor 405.

The method 500 starts, and in one embodiment, the server 105 receives 505 the service task 205. A resident account 115 may communicate the service task 205 through the communication channels 135 to the server 105.

In one embodiment, the server 105 generates 507 the task category 225 and the task location 230 from the service task 205. In addition, the server 105 may generate 507 the task category 225 and the task location 230 from the HOA data 350.

The server 105 may further generate 510 the work order 290 from the service task 205. The generation 510 of the work order 290 is described in more detail in FIG. 5B.

The server 105 may communicate 515 the work order 290 through the communication channels 135 to the maintenance worker account 125 that corresponds to the worker identifier 310 of the work order 290. In one embodiment, the server 105 accesses the worker contact information 335 using the worker identifier 310 and communicates 515 the work order 290 based on the worker contact information 335.

The server 105 may receive 520 the completion date 220, the task verification 355, and the work order identifier 335 from the maintenance worker account 125 when the work order 290 is complete. The combination of the completion date 220 and the task verification 355 may indicate that the work order 290 is completed.

The server 105 may further generate 525 the work order summary 390. In one embodiment, the work order summary 390 displays all uncompleted work orders 290 and the method 500 ends. Alternatively, the work order summary 390 may display all work orders 290 that were assigned to a specified maintenance worker within a specified time interval. For example, the work order summary 390 may display all work orders 290 assigned to a first maintenance worker for the past week.

FIG. 5B is a schematic flow chart diagram illustrating one embodiment of a work order generation method 600. The method 600 may perform the generate work order step 510 of FIG. 5A. The method 600 may be performed by the processor 405.

The method 600 starts, and in one embodiment, the server 105 selects 605 a maintenance worker profile 305 from the work order database 200. The server 105 may select 605 each maintenance worker profile 305 in turn.

The server 105 may calculate 610 a work classification score based on the work classification minimum required value of the task category 225 for the work order 290 and the work classification worker value of the worker skill set 315 for the maintenance worker profile 305. In one embodiment, the work classification score is calculated using Equation 1, where S is the work classification score, WV is the work classification worker value, MRV is the work classification minimum required value, and k is a negative constant.

S=WV−MRV if WV−MRV>0 else k Equation 1

The server 105 may further calculate 615 a relevant work experience score based on the relevant experience minimum required value of the task category 225 for the work order 290 and the relevant experience worker value of the worker skill set 315 from the maintenance worker profile 305. In one embodiment, the relevant work experience score is calculated using Equation 1, where S is the relevant work experience score, WV is the relevant work experience worker value, and MRV is the relevant work experience minimum required value.

In one embodiment, the server 105 calculates 620 a required training score based on the required training minimum required value of the task category 225 for the work order 290 and the required training worker value of the worker skill set 315 from the maintenance worker profile 305. In one embodiment, the required training experience score is calculated using Equation 1, where S is the required training score, WV is the required training worker value, and MRV is the required training minimum required value.

The server 105 may calculate 625 a required certification score based on the required certification minimum required value of the task category 225 for the work order 290 and the required certification worker value of the worker skill set 315 from the maintenance worker profile 305. In one embodiment, the required certification score is calculated using Equation 1, where S is the required certification score, WV is the required certification worker value, and MRV is the required certification minimum required value.

The server 105 may further calculate 630 a union requirement score based on the union requirement minimum required value of the task category 225 for the work order 290 and the union requirement worker value of the worker skill set 315 from the maintenance worker profile 305. In one embodiment, the union requirement score is k if the union requirement minimum required value indicates a union requirement in the union requirement worker value indicates no relevant union membership. Otherwise, the union requirement score may be zero.

The server 105 further calculate 635 an equipment score. In one embodiment, the equipment score is k if the worker equipment set 325 does not satisfy the equipment requirement 245 of the task category 225. Otherwise, the equipment score may be zero.

A unique value of k may be selected for each of the work classification score, relevant work experience score, required training score, required certification score, equipment score, and union requirement score.

The server 105 may further calculate 640 a schedule score based on the access time 280, the time requirement 240, and the worker schedule 320. In one embodiment, the schedule score is calculated using Equation 2, where SS is the schedule score, where j is a nonzero positive constant and SD is a number of days before the maintenance worker has the time requirement 240 available in the worker schedule 320 during the access time 280.

SS=j/SD Equation 2

The server 105 may determine 645 if all maintenance worker profiles 305 are evaluated. If all maintenance worker profiles 305 are not evaluated, the server 105 selects 605 a new maintenance worker profile 305. If all maintenance worker profiles 305 are evaluated, the server 105 selects 650 a maintenance worker profile 305 based on the work classification score, the relevant work experience score, the required training score, the required certification score, the union requirement score, the equipment score, and the schedule score. In one embodiment, the maintenance worker profile 305 with the highest nonzero sum of the work classification score, the relevant work experience score, the required training score, the required certification score, the union requirement score, the equipment score, and the schedule score is selected.

In one embodiment, a maintenance worker profile 305 is not selected 650 if the maintenance worker profile 305 does not satisfy one or more of the required training, required certification, and union requirement of the work type 235. In addition, the maintenance worker profile 305 may not be selected 650 if the worker equipment set 325 does not satisfy the equipment requirement 245.

In one embodiment, the server 105 generates 655 the work order 290 and the method 600 ends. The server 105 may generate 655 the work order 290 by generating the work order identifier 355. In addition, the server 105 may have the worker identifier 310 of the selected maintenance worker profile 305 added to the work order 290. The server 105 may further generate the schedule time 380 as a first time interval in the worker schedule 320 that coincides with the access time 280 and that satisfies the time requirement 240.

The server 105 may further generate the access requirement 250 for the work order 290 from the access requirement 250 of the task category 225, the task location 230, and the HOA data 350. The server 105 may generate the access procedures 270 for the work order 290 from the access procedures 270 of the HOA data 350.

In one embodiment, the server 105 specifies the task verification 355 for the work order 290. In addition, the server 105 may append the service task 205 to the work order 290.

The embodiments generate work orders 290 directed to a maintenance worker profile 305 based on a task category 225 and a task location 230 such that the maintenance worker profile 305 satisfies the task category 225 and the task location 230. As a result, the embodiments rapidly and efficiently allocate maintenance workers to service tasks 205 without excessive optimization calculations.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving, by use of a processor, a service task for a homeowners' association resident, the maintenance task comprising a task category and a task location;
generating a work order directed to a maintenance worker profile based on the task category and the task location, wherein the maintenance worker profile satisfies the task category and the task location; and
generating a work order summary.

2. The method of claim 1, wherein the work order summary comprises all active work orders.

3. The method of claim 1, wherein the work order summary comprises all active work orders for one or more specified task locations.

4. The method of claim 1, wherein the work order summary sorts work orders based on criteria comprising one or more of maintenance worker, homeowners' association, and date.

5. The method of claim 1, wherein the task category comprises a work type, a time requirement, an equipment requirement, and an access requirement.

6. The method of claim 1, wherein maintenance worker profile comprises a worker skill set, a worker schedule, a worker equipment set, and worker access devices.

7. The method of claim 1, wherein the task location comprises an address, a homeowners' association, access procedures, and an access requirement.

8. The method of claim 1, wherein the task location and the task category are generated from homeowners' association data.

9. An apparatus comprising:
a processor;
a memory storing code executable by the processor to:
receive a service task for a homeowners' association resident, the maintenance task comprising a task category and a task location;
generate a work order directed to a maintenance worker profile based on the task category and the task location, wherein the maintenance worker profile satisfies the task category and the task location; and
generate a work order summary.

10. The apparatus of claim 9, wherein the work order summary comprises all active work orders.

11. The apparatus of claim 9, wherein the work order summary comprises all active work orders for one or more specified task locations.

12. The apparatus of claim 9, wherein the work order summary sorts work orders based on criteria comprising one or more of maintenance worker, homeowners' association, and date.

13. The apparatus of claim 9, wherein the task category comprises a work type, a time requirement, an equipment requirement, and an access requirement.

14. The apparatus of claim 9, wherein maintenance worker profile comprises a worker skill set, a worker schedule, a worker equipment set, and worker access devices.

15. The apparatus of claim 9, wherein the task location comprises an address, a homeowners' association, access procedures, and an access requirement.

16. The apparatus of claim 9, wherein the task location and the task category are generated from homeowners' association data.

17. A program product comprising a non-transitory computer readable storage medium that stores code executable by a processor, the executable code comprising code to perform:
receiving a service task for a homeowners' association resident, the maintenance task comprising a task category and a task location;
generating a work order directed to a maintenance worker profile based on the task category and the task location, wherein the maintenance worker profile satisfies the task category and the task location; and
generating a work order summary.

18. The program product of claim 17, wherein the work order summary comprises all active work orders.

19. The program product of claim 17, wherein the work order summary comprises all active work orders for one or more specified task locations.

20. The program product of claim 17, wherein the work order summary sorts work orders based on criteria comprising one or more of maintenance worker, homeowners' association, and date.
